(19) United States
(12) Patent Application Publication
(10) Pub. No.: US 2020/0098197 A1
(43) Pub. Date: Mar. 26, 2020

(54) Control System For An Unmanned Highway Entrance

(71) Applicant: Chongqing Construction Engineering Group Corporation Limited, Chongqing (CN)

(72) Inventors: Yifei Wu, Chongqing (CN); Bo Chen, Chongqing (CN); Xiaojun Deng, Chongqing (CN); Zongyong Chen, Chongqing (CN); Peng Lv, Chongqing (CN); Nan Jiang, Chongqing (CN); Lei Luo, Chongqing (CN)

(73) Assignee: Chongqing Construction Engineering Group Corporation Limited, Chongqing (CN)

(21) Appl. No.: 16/156,564

(22) Filed: Oct. 10, 2018

(30) Foreign Application Priority Data
Sep. 21, 2018 (CN) 201811108371.6

(51) Int. Cl. G07B 15/06; G10L 13/04; H04R 1/00

(52) U.S. Cl. CPC G07B 15/063; H04R 1/005; G10L 13/043

(57) ABSTRACT

An control system for unmanned highway entrance is provided. The control system includes a server system and a toll collection system. The server system includes an unmanned entrance management system, a data center database, a speech synthesis component, and a speaker component. The unmanned entrance management system electrically is connected with the data center database, the speech synthesis component and the speaker component respectively. The toll collection system includes a data synchronization system, a toll collection database, a vehicle data collection system, a core data processing system, a watchdog system, a variable-message sign system, a card dispensing system, and an unmanned entrance toll collection system.

### CROSS-REFERENCE TO RELATED APPLICATIONS

The present disclosure claims priority of Chinese Patent Application No. 201811108371.6, filed to China Patent Office on Sep. 21, 2018. Contents of the present disclosure are hereby incorporated by reference in entirety of the Chinese Patent Application.

### TECHNICAL FIELD

The present disclosure relates to the field of a highway toll collection system, and in particular to a management system for an unmanned highway entrance.

### BACKGROUND

With rapid developments of the highway networks, more and more toll stations are needed at the highway network nodes, which results in an increasingly demand for human resource. Moreover, some operators who illegally pursue maximum profit adopt the illegal over-limit transport, which brings an extraordinary damage to safe driving or transport. When the vehicle exceeds the sum of the maximum allowable load, the inertia of vehicle may be increased and the braking distance also may be lengthened as a result of an increasing total mass of the vehicle, which may lead the vehicle to a more danger place. In addition, if the vehicle is in a seriously overload situation, it will cause accidents such as tire bursting, sudden partial driving, brake failure, and roller due to the tire load and excessive deformation.

Furthermore, the overload can also affect the steering performance, and meanwhile, the accidents caused by the power steering failure have become the primary reason for losing life on the highway road.

### SUMMARY

At least some embodiments of the present disclosure provide an control system for an unmanned highway entrance.

In one embodiment of the present disclosure, an control system for an unmanned highway entrance includes a server system and a toll collection system. The server system includes an unmanned entrance management system, a data center database, a speech synthesis component, and a speaker component. The unmanned entrance management system electrically is connected with the data center database, the speech synthesis component and the speaker component respectively. The toll collection system includes a data synchronization system, a toll collection database, a vehicle data collection system, a core data processing system, a watchdog system, a variable-message sign system, a card dispensing system, and an unmanned entrance toll collection system.

### BRIEF DESCRIPTION OF THE DRAWINGS

FIG. 1 is a framework of an control system for an unmanned highway entrance according to an embodiment of the present disclosure.

### DETAILED DESCRIPTION

Exemplary embodiments will now be described more comprehensively with reference to the drawings. However, the exemplary embodiments may be implemented in various forms and should not be understood to be limited to embodiments elaborated herein. On the contrary, these embodiments are provided to make the present disclosure comprehensive and complete and make the concept of the exemplary embodiments delivered to those skilled in the art comprehensively. The same reference numerals in the drawings denote the same or similar parts, and the repeated description thereof will be omitted.

In addition, described characteristics, structures or properties may be combined into one or more embodiments in any appropriate manner. Many specific details are provided in the following descriptions, thereby providing an adequate understanding to the embodiments of the present disclosure. However, those skilled in the art should realize that the technical solutions of the present disclosure may be implemented without one or more of the specific details, or other methods, components, materials, apparatuses, steps and the like may be adopted. Under other circumstances, well-known structures, methods, apparatuses, implementations, materials or operations are not shown or described in detail to avoid each aspect of the present disclosure being obscured.

The block diagrams shown in the figures are functional entities and do not necessarily have to correspond to physically separate entities. That is, these functional entities may be implemented in software, or these functional entities or some of the functional entities are implemented in one or more software-hardened components, or these functional entities are implemented in different networks and/or processor apparatuses and/or micro-controller apparatuses.

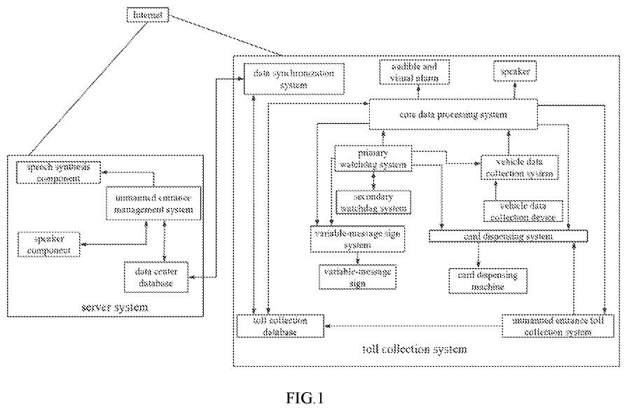

FIG. 1 is a framework of an embodiment of the present application. In FIG. 1, a control system for an unmanned highway entrance includes a server system and a toll collection system. The server system includes an unmanned entrance management system, a data center database, a speech synthesis component, and a speaker component. The unmanned entrance management system electrically is connected with the data center database, the speech synthesis component and the speaker component respectively. The toll collection system includes a data synchronization system, a toll collection database, a vehicle data collection system, a core data processing system, a watchdog system, a variable-message sign system, a card dispensing system, and an unmanned entrance toll collection system.

In the present embodiment, the unmanned entrance management system includes system setting, over-limit management, and statistical query.

In the present embodiment, the system setting includes a role setting, an operator setting, a role query, and an operator query. The role setting is configured to set a role information and a limit of authority of a role. The operator setting allows operators to record and maintain information of operators, and to set roles of operator and limits of authorities of the operators. The role query is configured to query the role information and the limits of authority that has been set. And the operator query is configured to query information of operators according to limits of the present user.

In the present embodiment, the over-limit management includes an over-limit parameter setting, a variable-message sign setting, a toll collection management, a blacklist management, an over-limit transport license management, an over-limit speech alarm setting, an over-limit parameter query, a variable-message sign query, a toll collection query, a blacklist query, and an over-limit transport license query.

In an alternative embodiment, the over-limit parameter includes but not limits to the following information: numbers of axles, allowable load for a vehicle, valid (Y/N), person who record the over-limit parameter, date when the over-limit parameter is record, person who modify the over-limit parameter, last date when the over-limit parameter is modified. In an alternative embodiment, the numbers of axles and the allowable load corresponding the numbers of axles are pre-record into the unmanned entrance management system in order to accomplish a over-limit table. The variable-message sign setting is configured to set priority level of information displayed on a variable-message sign according to categories of information, in the present embodiment, the categories of information includes: information related to no vehicle passing, information related to legal vehicle, information related to over-limit vehicle, and information related to blacklisted vehicle. In the present embodiment, the information displayed on variable-message sign can be changed according to the different situation.

For example, when there is no vehicle passing through, the variable-message sign show a particular slogan; when a vehicle travels into an entrance and a weigh in motion (WIM) system detects a total mass of the vehicle, if the total mass detected does not exceed a maximum threshold of a total mass of the vehicle, the variable-message sign shows the information related to the legal vehicle allowing the vehicle to pass, but if the vehicle is over-limit, then the variable-message sign shows the information related to the over-limit vehicle and specific over-limit numbers; if the vehicle is a blacklisted vehicle, then the blacklisted vehicle is not allowed to pass travelling on the highway.

In an alternative embodiment, the toll collection management is configured to record information of the toll collection according to a toll collection needed to be managed, for example, the information of the toll collection may include a toll collection number, a toll collection name, and number of entrances of the toll collection.

In an alternative embodiment, the blacklist management may include vehicle plate number, vehicle description, data source, toll collection, number of an entrance of a toll collection, person who record the blacklist, and date when the blacklist is record. In the present, the data source show data imported from other databases such as data imported from a vehicle management system.

In an alternative embodiment, the over-limit speech alarm setting includes default speech alarm and real-time speech alarm. And the over-limit speech alarm setting provides different kinds of speech notification, for example, male voice or female voice can be selected through a Down-drop menu. In the default speech alarm, a speech text is provided with: over-limit, please exit or wait for artificial processing. In the real-time speech alarm, speech text is provided according to the following aspects: vehicle plate number, ‘over-limit’, real-time load amount, allowable load for the vehicle, over-limit load amount.

When operators who use the unmanned entrance management system have set the value of different system above, the operators can query the setting information.

In an alternative embodiment, the statistical query includes a passing vehicle query, an over-limit vehicle query, and a blacklisted vehicle query. In an alternative embodiment, the passing vehicle query provides a search for passing vehicle information of different time periods such as last week, last month and so on. In an alternative embodiment, the passing vehicle information may include toll collection number, number of entrances of the toll collection, date when the vehicle is allowed to pass, vehicle plate number, numbers of axles, real-time load amount, allowable load for the vehicle, over-limit (Y/N), over-limit transport license number, allowable load of the over-limit transport license. In an alternative embodiment, the over-limit vehicle query provide a search for over-limit vehicles information those once were blocked to travel on the highway, the over-limit vehicles information may includes: vehicle plate number, numbers of axles, real-time load amount, allowable load for the vehicle, over-limit load amount, over-limit transport license number, and allowable load of the over-limit transport license. In an alternative embodiment, the blacklisted vehicle query provides a search for blacklisted vehicle information including vehicle plate number, numbers of axles, real-time load amount, allowable load for the vehicle, and description for blacklist.

The data center database is configured to store information data of the unmanned entrance management system.

The speech synthesis component is configured to synthesize a passing vehicle and a real-time load amount of the passing vehicle to alert and guide an operator of the passing vehicle.

The speaker component is configured to play an alarm message to inform a collector to operate the unmanned entrance management system.

The data synchronization system is configured to synchronize data of the data center database and data of the toll collection database. In an alternative embodiment, the data synchronization system is configured to implement the following steps:
1) unilaterally synchronizing information of the data center database to the toll collection database, wherein the information of the data center database includes a variable-message sign table, a over-limit parameter table, a speech parameter table and a vehicle information table;
2) unilaterally synchronizing information of the toll collection database to the data center database, wherein the information of the toll collection database includes the passing vehicle table, the blacklisted table and the over-limit table;

3) bilaterally synchronizing the toll collection database and the data center database, wherein an information related to bilateral synchronization includes a over-limit transport license table and a blacklist table.

In an alternative embodiment, the vehicle data collection system connected with a vehicle data collection device is configured to collect information of a plate number, a real-time load amount and numbers of axles of a vehicle, to parse the information collected, and to send the parsed information to the core data processing system through an internal data communication protocol.

In an alternative embodiment, the core data processing system is configured to receive and compare vehicle information collected and sent by the vehicle data collection system with the over-limit parameters read from the toll collection database to determine whether the vehicle is over-limit, and with information read from the blacklist to determine whether the vehicle is blacklisted.

In an alternative embodiment, the card dispensing system is configured to receive information sent from the core data processing system, and write a registered information of the vehicle and a vehicle plate recognition result to a card, and determine whether the vehicle is allowed to pass.

In an alternative embodiment, the variable-message sign system is configured to receive and display information sent from the core data processing system.

In an alternative embodiment, the watchdog system comprises a primary watchdog system and a secondary watchdog system to ensure that the control system for unmanned highway entrance works steadily under an unmanned condition. The primary watchdog system monitors following systems, and restarts the system determined to be offline, the following systems includes: the vehicle data collection system, the core data processing system, the card dispensing system, the variable-message sign system and the secondary watchdog system. The secondary watchdog system monitors the primary watchdog system, and when the primary watchdog system is determined to be offline, the secondary watchdog system restarts the primary watchdog system immediately.

In an alternative embodiment, the unmanned entrance toll collection system is configured to receive vehicle information sent from the core data processing system, wherein the vehicle information includes plate number, real-time load amount, allowable load for the vehicle, result of pass-through, information of the blacklist, over-limit transport license number, start date of the over-limit transport license, and allowable load of the over-limit transport license.

In an alternative embodiment, the toll collection database is configured to store information data of the unmanned entrance toll collection system.

In the present embodiment, the core data processing system is electrically connected with an audible and visual alarm, and a speaker.

In the present embodiment, the unmanned entrance toll collection system is provided with a graphic user interface (GUI). The GUI display the vehicle information in real time.

In an alternative embodiment, a top of a screen of the GUI show information of the vehicles entering the entrance recently, a bottom of the screen of the GUI show a current queue of the vehicles, the maximum number of the queue of the vehicles is κ. The GUI is configured to select a particular vehicle by an input device such as a mouse, and then the users could allow the selected vehicle to pass, record the over-limit transport license of the selected vehicle, or record the selected vehicle into a blacklist through the GUI.

The GUI also is configured to input the information of the over-limit transport license to update an over-limit transport license table. When a particular over-limit vehicle is selected, the GUI provides a button of inputting the over-limit transport, and in response to pressing the button, the GUI show an interface of inputting the over-limit transport license.

The vehicle plate number is automatically imported into the interface, and the users are allowed to input the over-limit transport license information such as: the over-limit transport license number, start date of the over-limit transport license, end data of the over-limit transport license, allowable load of the over-limit transport license, and comments. And then save the over-limit transport license information above to the toll collection database, and synchronize to the over-limit transport license information to the data center database.

Moreover, the GUI is also configured to record information of the backlist to update a blacklist table. The GUI provides a button of recording the blacklist. The button is available no matter whether there is a selected vehicle. In the present embodiment, if the button is pressed with a vehicle being selected, a plate number of the selected vehicle may be imported automatically, and the users are allowed to record the blacklist information such as: a vehicle plate number, description of the blacklist, and comments. And then save the blacklist information above to the toll collection database, and synchronize to the blacklist information to the data center database.

Furthermore, the unmanned entrance toll collection system is configured to manually allow the over-limit vehicle to pass. In an alternative embodiment, if a vehicle satisfies at one of the following limitations, the vehicle can be allow to travel on the highway, the limitation includes: vehicle that does not exceed the limit, vehicle that is blacklisted but is allowed to pass, vehicle that is over-limit but is allowed to pass without an over-limit transport license, vehicle with an over-limit transport license that is over-limit but is allowed to pass.

In the present embodiment, the unmanned entrance toll collection system is configured to resend passing vehicle information resetting queue of the passing vehicle, and write data of passing vehicle allowed manually into the toll collection database.

In an alternative embodiment, the core data processing system is configured to implement the following steps:

sending information of legal vehicle to the card dispensing system;

sending information of legal vehicle or over-limit vehicle or blacklist to the variable-message sign system;

sending the vehicle information to the unmanned entrance toll collection system, wherein the information includes plate number, real-time load amount, allowable load for the vehicle, result of pass-through, information of the blacklist, over-limit transport license number, start date of the over-limit transport license, and allowable load of the over-limit transport license;

writing the information of legal vehicle into a passing vehicle table of the toll collection database;

writing information of blacklisted vehicle into a blacklisted table of the toll collection database;

writing information of the over-limit vehicle into a over-limit table of the toll collection database;

determining a vehicle is an blacklisted vehicle or an over-limit vehicle, initiate the audible and visual alarm to inform a collector to intervene;

in response to determining a vehicle is an over-limit vehicle, using the speaker to play an speech synthesized online according to an over-limit speech alarm set by the unmanned entrance management system.

In an alternative embodiment, a telecommunication link between the data center database and the data synchronization system is the Wide Area Network; a telecommunication link between the unmanned entrance management system, the data center database and the speech synthesis component is the Wide Area Network; a telecommunication link between the vehicle data collection system, the core data processing system, the variable-message sign system, the card dispensing system, the watchdog system, the unmanned entrance toll collection system, and the toll collection database is the Local Area Network; a telecommunication link between the variable-message sign system and a variable-message sign is the Local Area Network; a telecommunication link between the vehicle data collection system and the vehicle data collection device is RS-232 Serial Communication; a telecommunication link between the card dispensing system, a card dispensing machine, and a relay is RS-232 Serial Communication; a telecommunication link between the core data processing system, the audible and visual alarm, and the speaker is RS-232 Serial Communication.

In an alternative embodiment, the vehicle data collection device includes a piezoelectric sensor collecting numbers of axles and tires of the vehicle, a weigh in motion (WIM) system, and a plate of vehicle recognition device. In an embodiment, the piezoelectric sensor includes a parallel component, an inclined component, a control component, and a processing component. The parallel component includes a pressure sensor A and a pressure sensor B, and there is a particular distance between the pressure sensor A and the pressure sensor B. The parallel component is configured to collect numbers of axles and wheelbase, furthermore, the parallel component can also be used to collect wheelbase of the vehicle with the inclined component.

The inclined component includes a piezoelectric sensor C which inclines at an angle of 45 degree. The inclined component is configured to calculate numbers of tires.

The control component is configured to send signals to control the piezoelectric sensor to run.

The processing component is configured to process and transport data. For example, the process component detect and recognize a vehicle structure basing on the signal collected by other components. The details will be described below.

When vehicle tire pass over the piezoelectric sensor C, the piezoelectric sensor C detects the vehicle tire and generates an analog signal which is proportional to the pressure, and the period of outputting the analog signal is same as the time of vehicle staying on the sensor C. The sensor C generates a new analog signal ever time when a vehicle tire passes over the sensor C. For example, when a vehicle passes over the sensor C with a vehicle tire pressing on the sensor C, the sensor C detects a changeable pressure ΔP and generates an electrical charge Q corresponding to the pressure ΔP, and the electrical charge Q is proportional to the pressure ΔP and a length L1 of a part of the sensor C pressed by the vehicle tire. In the present embodiment, the electrical charge Q is Q=kAP*L1, and then, the pressure ΔP is ΔP=Q/(k*L1), and the integral of ΔP is P=(k*L1)−1Error! Reference source not found.

According to the analysis above, we can calculate the particular element basing on voltage or current, the details will be described below.

(1) speed of vehicle. The parallel component may be applied to calculate speed of vehicle. Initiate an electronic clock when a vehicle tire presses the sensor A, and stop the electronic clock when the vehicle tire presses the sensor B, and then get the time period Δt. According to the distance L2 between the sensor A and the sensor B, we can get the speed of vehicle V is V=L2/Δt.

(2) wheelbase. Because the vehicle moves with a constant velocity within the range of L2, we can get the wheelbase by having the time period ΔT of generating signal by a particular sensor multiplied by the speed of vehicle V.

(3) numbers of axles. Because an object detected by senor is pressure applied by a vehicle tire, therefore, we can use the sensor to calculate number of axles easily, even though, two tires are arranged very close. By counting up times of generating signal, we can get numbers of axles.

(4) numbers of tires. The inclined component is configured to detect numbers of tires. When a single row tire passes though and presses the sensor, the sensor generate one pulse. When a double row tire passes though and presses the sensor, the sensor generate two pulse.

(5) track. The parallel component with the inclined component can calculate the track. The formula is S=cot(a)*V*Δt1=cot(a)*L2*Δt1/Δt, where a is the angle of sensor A and sensor C, V is the speed of vehicle, L2 is the distance between the sensor A and sensor B, Δt1 is the time period of the front tire passing though the sensor C, and Δt is the time period of the vehicle passing through the sensor A and the sensor B.

In an alternative embodiment, the WIM system includes a dynamic axle weighing platform, an infrared vehicle separator, a wheel identifier, a ground sense coil, a control cabinet and communication tools and so on.

In the present embodiment, the wheel identifier is configured to detect and recognize the vehicle and the pressure of the vehicle tires. The wheel identifier uses data to calculate the mass of vehicle, speed, wheelbase and structure of vehicle. The WIM system and a vehicle plate recognition device are arranged in front of the the toll collection system at a particular distance. When a vehicle passes through the dynamic axle weighing platform, the infrared vehicle separator detects the vehicle generating a signal controlling the dynamic axle weighing platform to work. When the vehicle tires of one axle move on the dynamic axle weighing platform, a weighing sensor generates a signal proportional to the weight, the dynamic axle weighing platform calculate one dynamic axle weighting through magnifying and converting and processed by computer, and after the vehicle passes through the dynamic axle weighing platform completely, add result of the each the dynamic axle weighting together to get the total mass of the vehicle.

In an alternative embodiment, a method of establishing a mathematical model can be adopted. Parameters of the model are fitted according to the data measured, and thereby achieving the effect of suppressing interference. Because the signal generated by the WIM system is mixed with a linear term changing in accordance with the time caused by static load and a periodic oscillation term of an amplitude value caused by dynamic load, the formula is

Y(t)=kt+Σᵢ₌₁^{p}Ai sin(2π Bit+Ci),

where Y(t) is mathematical model, k is a rate of change of signal caused by static load moving along the weighting platform, Ai is a rate of change of dynamic load amplitude of different frequency in the signal with time, Bi is a frequency of dynamic load of different frequency, Ci is a phase of dynamic load of different frequency, p is numbers of different frequency included in the dynamic load periodic interference of vehicle tires. Actually, when p<3, the ratio of suppressing signal interference can be greater than 30˜40 dB, for the reason that a method for filtering during the pre-processing process can effectively move the high frequency components. And then adopt a parameter fitting by Non-linear least squares. Therefore, the WIM system may guarantee the accuracy of the system while improving the passing speed of the vehicle.

In an alternative embodiment, the plate of vehicle recognition device is configured to recognize the vehicle plate through collecting and converting the image, extracting edge, locating and carving a part of vehicle plate in the image, carving the characters of vehicle plate, and comparing.

In an alternative embodiment, the data center database is connected with a vehicle management system, the vehicle management system is configured to unilaterally synchronize a vehicle table to the data center database, and a blacklist table is bilaterally synchronized between the data center database and the vehicle management system.

In an alternative embodiment, the data center database reads the vehicle table from the vehicle management system and sends the vehicle table to the toll collection database of the toll collection system. The core data processing system reads numbers of axles from the toll collection database and determines whether numbers of axles of the vehicle information received from the vehicle data collection system is in accord with numbers of axles read from the toll collection database. In response to received numbers of axles being in accord with read numbers, the core data processing system sends a signal to the card dispensing system, and in response to received numbers of axles not being in accord with read numbers, the core data processing system control a camera to reconfirm. Therefore, the control system acquires the vehicle information through communication of vehicle and internet of vehicle, meanwhile, the control system adopts automatic acquisition technology to collect information to reconfirm to achieve a effect of high accuracy.

In an alternative embodiment, the server system is connected with more than two toll collection systems.

In the present embodiment, operators set the over-limit parameter, the speech parameter and the variable-message sign information through the unmanned entrance management system, and save these data into the data center database.

When a vehicle is going to drive into the highway entrance, the vehicle data collection device collects the vehicle information such as plate number, numbers of axles and real-time load amount, and sends the vehicle information to the vehicle data collection system. The vehicle data collection system parses the vehicle information sent from the vehicle data collection device, and uploads the vehicle information to the core data processing system. The core data processing system determines whether the vehicle information collected by the vehicle data collection system is accurate basing on the vehicle table stored in the toll collection database. If the vehicle information collected is accurate, the core data processing system reads the over-limit parameter table and the blacklist table from the toll collection database, and determines whether the vehicle is over-limit or blacklisted basing on the over-limit parameter table and the blacklist table. And the unmanned entrance toll collection system display the result determined by the core data processing system. At the same time, the core data processing system sends the vehicle information to the variable-message sign system, thereby displaying the vehicle information. If the vehicle satisfies the limit of allowing to pass, the core data processing system sends the vehicle structure and the information of the vehicle plate recognition to the card dispensing system. The card dispensing system write these information to a passing card. If the vehicle does not satisfies the limit of allowing to pass, the core data processing system controls the audible and visual alarm to inform a collector to intervene manually allowing the vehicle to pass. And record the manually passing vehicle information to the toll collection database through the unmanned entrance toll collection system. Then, the toll collection database synchronizes the manually passing vehicle information to the data center database to save by the data synchronization system.

Those skilled in the art will appreciate that various aspects of the present disclosure may be implemented as a system, method, or program product. Therefore, various aspects of the present disclosure may be embodied in the form of a complete hardware implementation manner, a complete software implementation manner (including firmware, microcode, etc.), or a combined implementation manner of hardware and software, which may be collectively referred to as “circuit”, “component” or “system”.

Other embodiments of the present disclosure will be apparent to those skilled in the art after considering the specification and practicing the present disclosure herein. The present application is intended to cover any variations, uses, or adaptations of the present disclosure, which are in accordance with the general principles of the present disclosure and include common general knowledge or conventional technical means in the art that are not disclosed in the present disclosure. The specification and examples are to be regarded as illustrative only, and the true scope and spirit of the present disclosure are limited only by the appended claims.

What is claimed is:

1. A control system for an unmanned highway entrance, the control system including a server system and a toll collection system,
the server system comprising:
an unmanned entrance management system comprising:
a system setting, comprising a role setting, an operator setting, a role query, and an operator query;
an over-limit management, comprising an over-limit parameter setting, a variable-message sign setting, a toll collection management, a blacklist management, an over-limit transport license management, an over-limit speech alarm setting, an over-limit parameter query, a variable-message sign query, a toll collection query, a blacklist query, and an over-limit transport license query;
a statistical query, comprising a passing vehicle query, an over-limit vehicle query, and a blacklisted vehicle query;
a data center database configured to store information data of the unmanned entrance management system;
a speech synthesis component configured to synthesize a passing vehicle and a real-time load amount of the passing vehicle to alert and guide an operator of the passing vehicle;
a speaker component configured to play an alarm message to inform a collector to operate the unmanned entrance management system;
wherein the unmanned entrance management system electrically connected with the data center database, the speech synthesis component and the speaker component respectively;
the toll collection system comprising:
a data synchronization system, a toll collection database, a vehicle data collection system, a core data processing system, a watchdog system, a variable-message sign system, a card dispensing system, and an unmanned entrance toll collection system,
wherein,
the data synchronization system is configured to synchronize data of the data center database and data of the toll collection database;
the vehicle data collection system connected with a vehicle data collection device is configured to collect information of a plate number, a real-time load amount and numbers of axles of a vehicle, to parse the information collected, and to send the parsed information to the core data processing system through an internal data communication protocol;
the core data processing system is configured to receive and compare vehicle information collected and sent by the vehicle data collection system with the over-limit parameters read from the toll collection database to determine whether the vehicle is over-limit, and with information read from the blacklist to determine whether the vehicle is blacklisted;
the card dispensing system is configured to receive information sent from the core data processing system, and write a registered information of the vehicle and a vehicle plate recognition result to a card, and determine whether the vehicle is allowed to pass;
the variable-message sign system is configured to receive and display information sent from the core data processing system.
the watchdog system is configured to ensure that the control system works steadily under an unmanned condition;
the unmanned entrance toll collection system is configured to receive vehicle information sent from the core data processing system, wherein the vehicle information includes plate number, real-time load amount, allowable load for the vehicle, result of pass-through, information of the blacklist, over-limit transport license number, start date of the over-limit transport license, and allowable load of the over-limit transport license;
the toll collection database is configured to store information data of the unmanned entrance toll collection system.

2. the control system as claimed in claim 1, wherein the core data processing system is electrically connected with an audible and visual alarm, and a speaker.

3. the control system as claimed in claim 1, wherein the unmanned entrance toll collection system is configured to display the vehicle information in real time, input information of the over-limit transport license, record information of the backlist, manually allow the over-limit vehicle to pass, resend passing vehicle information resetting queue of the passing vehicle, and write data of passing vehicle allowed manually into the toll collection database.

4. the control system as claimed in claim 2, wherein the core data processing system is configured to implement the following steps:
sending information of legal vehicle to the card dispensing system;
sending information of legal vehicle or over-limit vehicle or blacklist to the variable-message sign system;
sending the vehicle information to the unmanned entrance toll collection system, wherein the information includes plate number, real-time load amount, allowable load for the vehicle, result of pass-through, information of the blacklist, over-limit transport license number, start date of the over-limit transport license, and allowable load of the over-limit transport license;
writing the information of legal vehicle into a passing vehicle table of the toll collection database;
writing information of blacklisted vehicle into a blacklisted table of the toll collection database;
writing information of the over-limit vehicle into a over-limit table of the toll collection database;
determining a vehicle is a blacklisted vehicle or an over-limit vehicle, initiate the audible and visual alarm to inform a collector to intervene;
in response to determining a vehicle is an over-limit vehicle, using the speaker to play a speech synthesized online according to an over-limit speech alarm set by the unmanned entrance management system.

5. the control system as claimed in claim 1, wherein
a telecommunication link between the data center database and the data synchronization system is the Wide Area Network,
a telecommunication link between the unmanned entrance management system, the data center database and the speech synthesis component is the Wide Area Network,
a telecommunication link between the vehicle data collection system, the core data processing system, the variable-message sign system, the card dispensing system, the watchdog system, the unmanned entrance toll collection system, and the toll collection database is the Local Area Network,
a telecommunication link between the variable-message sign system and a variable-message sign is the Local Area Network,
a telecommunication link between the vehicle data collection system and the vehicle data collection device is RS-232 Serial Communication,
a telecommunication link between the card dispensing system, a card dispensing machine, and a relay is RS-232 Serial Communication,
a telecommunication link between the core data processing system, the audible and visual alarm, and the speaker is RS-232 Serial Communication.

6. the control system as claimed in claim 1, wherein the data synchronization system is configured to implement the following steps:
unilaterally synchronizing information of the data center database to the toll collection database, wherein the information of the data center database includes a variable-message sign table, an over-limit parameter table, a speech parameter table and a vehicle information table;
unilaterally synchronizing information of the toll collection database to the data center database, wherein the information of the toll collection database includes the passing vehicle table, the blacklisted table and the over-limit table;
bilaterally synchronizing the toll collection database and the data center database, wherein an information related to bilateral synchronization includes a over-limit transport license table and a blacklist table.

7. the control system as claimed in claim 1, wherein the vehicle data collection device comprises a piezoelectric sensor collecting numbers of axles and tires of the vehicle, a weigh in motion (WIM) system, and a plate of vehicle recognition device.

8. the control system as claimed in claim 1, wherein the data center database is connected with a vehicle management system, the vehicle management system is configured to unilaterally synchronize a vehicle table to the data center database, and a blacklist table is bilaterally synchronized between the the data center database and the vehicle management system.

9. the control system as claimed in claim 8, wherein
the data center database reads the vehicle table from the vehicle management system and sends the vehicle table to the toll collection database of the toll collection system,
the core data processing system reads numbers of axles from the toll collection database and determines whether numbers of axles of the vehicle information received from the vehicle data collection system is in accord with numbers of axles read from the toll collection database,
in response to received numbers of axles being in accord with read numbers, the core data processing system sends a signal to the card dispensing system, and
in response to received numbers of axles not being in accord with read numbers, the core data processing system control a camera to reconfirm.

10. the control system as claimed in claim 1, wherein the watchdog system comprises a primary watchdog system and a secondary watchdog system,
the primary watchdog system monitors following systems, and restarts the system determined to be offline, the following systems includes: the vehicle data collection system, the core data processing system, the card dispensing system, the variable-message sign system and the secondary watchdog system;
the secondary watchdog system monitors the primary watchdog system, and when the primary watchdog system is determined to be offline, the secondary watchdog system restarts the primary watchdog system.

11. the control system as claimed in claim 1, wherein the role setting is configured to set a role information and a limit of authority of a role; the operator setting is configured to record and maintain information of operators, and to set roles of operator and limits of authorities of the operators.

12. the control system as claimed in claim 1, wherein the over-limit parameter comprises the following information: numbers of axles, allowable load for a vehicle, valid (Y/N), person who record the over-limit parameter, date when the over-limit parameter is record, person who modify the over-limit parameter, last date when the over-limit parameter is modified.

13. the control system as claimed in claim 1, wherein the variable-message sign setting is configured to set priority level of information displayed on a variable-message sign according to categories of information.

14. the control system as claimed in claim 1, wherein the over-limit speech alarm setting comprises default speech alarm and real-time speech alarm, and a speech text of the real-time speech alarm is provided according to the following aspects: vehicle plate number, ‘over-limit’, real-time load amount, allowable load for the vehicle, over-limit load amount.

15. the control system as claimed in claim 7, wherein the piezoelectric sensor comprises:
a parallel component configured to collect numbers of axles and wheelbase;
an inclined component configured to calculate numbers of tires;
a control component configured to send signals to control the piezoelectric sensor to run; and a processing component configured to process and transport data.

16. the control system as claimed in claim 7, wherein the WIM system comprises a dynamic axle weighing platform, an infrared vehicle separator, a wheel identifier, a ground sense coil, a control cabinet and communication tools.

17. the control system as claimed in claim 16, wherein the WIM system adopts a mathematical model, and parameters of the mathematical model are fitted according to data measured to suppress interference.

18. the control system as claimed in claim 3, wherein the unmanned entrance toll collection system is provided with a graphic user interface.

19. the control system as claimed in claim 18, wherein when a particular over-limit vehicle is selected, the GUI provides a button of inputting the over-limit transport, and in response to pressing the button, the GUI shows an interface of inputting the over-limit transport license.

20. A control system for an unmanned highway entrance, the control system comprising a server system and a toll collection system, the server system comprising an unmanned entrance management system, a data center database, a speech synthesis component, and a speaker component; the toll collection system comprising a data synchronization system, a toll collection database, a vehicle data collection system, a core data processing system, a watchdog system, a variable-message sign system, a card dispensing system, and an unmanned entrance toll collection system; wherein the unmanned entrance management system is electrically connected with the data center database, the speech synthesis component and the speaker component respectively.
